(19) United States
(12) Patent Application Publication
(10) Pub. No.: US 2015/0194707 A1
(43) Pub. Date: Jul. 9, 2015

(54) BATTERY PACK, ENERGY STORAGE SYSTEM INCLUDING THE BATTERY PACK, AND METHOD OF OPERATING THE BATTERY PACK

(71) Applicant: Samsung SDI Co., Ltd., Yongin-si (KR)

(72) Inventor: Jin-Hyuk Park, Yongin-si (KR)

(21) Appl. No.: 14/565,353

(22) Filed: Dec. 9, 2014

(30) Foreign Application Priority Data
Jan. 6, 2014 (KR) 10-2014-0001498

(51) Int. Cl. H01M 10/42

(52) U.S. Cl. CPC H01M 10/4257; H01M 10/4207; H01M 2010/4271

(57) ABSTRACT

A battery pack including a plurality of batteries and a battery management unit is provided. The plurality of batteries are configured to be selectively coupled in parallel through module switches. The battery management unit is configured to detect a module voltage of each of the plurality of batteries, control the module switches to couple the plurality of batteries in parallel in an ascending order of the module voltage from a battery having a lowest module voltage to a battery having a highest module voltage in a charge mode, and control the module switches to couple the plurality of batteries in parallel in a descending order of the module voltage from the battery having the highest module voltage to the battery having the lowest module voltage in a discharge mode.

### CROSS-REFERENCE TO RELATED APPLICATION

This application claims priority to and the benefit of Korean Patent Application No. 10-2014-0001498, filed on Jan. 6, 2014, in the Korean Intellectual Property Office, the disclosure of which is incorporated herein in its entirety by reference.

### BACKGROUND

1. Field

Aspects of embodiments of the present invention relate to a battery pack, an energy storage system including the battery pack, and a method of operating the battery pack.

2. Description of the Related Art

An energy storage system is generally a storage apparatus for improving energy efficiency and stably operating an electric power system by storing electric power when a demand for the electric power is low, and using the stored electric power when the demand for the electric power is high. Recently, as the supply of smart grids and new and renewable energy have expanded, and efficiency and stability of an electric power system are emphasized, a demand for an energy storage system has increased in order to adjust to the supply and demand of the electric power and to improve electric power quality. An electric power system has different outputs and capacities according to purposes of its use. In the case of a large-capacity energy storage system, battery modules are coupled (e.g., connected) in parallel, and inrush current may be generated when the battery modules having a voltage difference are coupled in parallel. The inrush current may cause degradation (e.g., breakdowns) of the battery modules or the energy storage system.

### SUMMARY

Aspects of embodiments of the present invention relate to a battery pack capable of substantially preventing an occurrence of inrush current, an energy storage system including the battery pack, and a method of operating the battery pack.

Additional aspects will be set forth in part in the description which follows and, in part, will be apparent to those having ordinary skill in the art from the description, or from practice of the presented embodiments.

According to one or more embodiments of the present invention, a battery pack includes: a plurality of batteries configured to be selectively coupled in parallel through module switches; and a battery management unit configured to: detect a module voltage of each of the plurality of batteries; control the module switches to couple the plurality of batteries in parallel in an ascending order of the module voltage from a battery having a lowest module voltage to a battery having a highest module voltage in a charge mode; and control the module switches to couple the plurality of batteries in parallel in a descending order of the module voltage from the battery having the highest module voltage to the battery having the lowest module voltage in a discharge mode.

The plurality of batteries may include a first battery having the lowest module voltage and a second battery having a second lowest module voltage. The module switches may include a first module switch corresponding to the first battery, and a second module switch corresponding to the second battery. The battery management unit, in the charge mode, may be configured to charge the first battery by closing the first module switch, and to charge both the first battery and the second battery by closing the second module switch when the module voltage of the first battery increases, and a difference between the module voltage of the first battery and that of the second battery is smaller than a threshold value.

The plurality of batteries may include a first battery having the highest module voltage, and a second battery having a second highest module voltage. The module switches may include a first module switch corresponding to the first battery and a second module switch corresponding to the second battery. In a discharge mode, the battery management unit may be configured to discharge the first battery by closing the first module switch, and may discharge both the first battery and the second battery by closing the second module switch when the module voltage of the first battery decreases, and a difference between the module voltage of the first battery and that of the second battery is smaller than a threshold value.

The plurality of batteries may include first batteries coupled in parallel through first module switches that are in a closed state, and a second battery coupled to a second module switch that is in an open state. When the first batteries are charged or discharged and a difference between the module voltages of the first batteries and the module voltage of the second battery is smaller than a threshold value, the battery management unit may be configured to couple the second battery to the first batteries by closing the second module switch.

The plurality of batteries may include a first battery having a first module voltage, and a second battery having a second module voltage. When a difference between the module voltage of the first battery and that of second battery is smaller than a threshold value, the battery management unit may be configured to close a first module switch corresponding to the first battery, and may be configured to immediately close a second module switch corresponding to the second battery without charging or discharging the first battery.

The battery pack may further include module management units and battery modules configured to be selectively coupled in parallel. Each of the battery modules may include: a battery from among the plurality of batteries; a module switch from among the module switches coupled to the battery in series; and a module management unit from among the module management units configured to detect the module voltage of the battery, and to control closing and opening of the module switch.

The battery management unit may include the module management units and a main management unit configured to communicate with each other. The main management unit may be configured to receive the module voltages of the batteries from the module management units, and to transmit control commands to control the module switches to the module management units. The module management units may be configured to receive the control commands from the main management unit, and to close or open the module switches according to the control commands.

The battery pack may further include a main switch coupled between the battery modules and an output terminal. The main management unit may be configured to control closing and opening of the main switch such that the main switch is open at a time when the module switches are switched from an open state to a closed state.

According to another embodiment of the present invention, an energy storage system includes a battery system and a power conversion system. The battery system includes: a plurality of batteries selectively coupled in parallel through corresponding module switches; and a battery management unit configured to detect a module voltage of each of the plurality of batteries, control the module switches in order to couple the plurality of batteries in an ascending order of the module voltage in a charge mode, and control the module switches in order to couple the plurality of batteries in a descending order of the module voltage in a discharge mode. The power conversion system includes: power conversion apparatuses configured to convert electric power between the battery system and an electric power generator, a grid system, and/or a load; and an integrated controller configured to control the power conversion apparatuses.

The plurality of batteries may include a first battery having a lowest module voltage, and a second battery having a second lowest module voltage. The battery management unit may be configured to charge the first battery by closing a module switch corresponding to the first battery in the charge mode, and may be configured to couple the second battery to the first battery in parallel by closing a module switch corresponding to the second battery when the module voltage of the first battery increases and the module voltage of the first battery becomes substantially the same as that of the second battery.

The plurality of batteries may include a first battery having a highest module voltage, and a second battery having a second highest module voltage. The battery management unit may be configured to discharge the first battery by closing a module switch corresponding to the first battery in the discharge mode, and may be configured to couple the second battery to the first battery in parallel by closing a module switch corresponding to the second battery when the module voltage of the first battery decreases and the module voltage of the second battery becomes substantially the same as that of the first battery.

The plurality of batteries may include first batteries coupled in parallel through first module switches that are closed, and a second battery coupled to a second module switch that is opened. The battery management unit may be configured to couple the second battery to the first batteries in parallel by closing the second module switch when the first batteries are charged or discharged, and the module voltages of the first batteries become substantially the same as the module voltage of the second battery.

The plurality of batteries may include a first battery having a first module voltage, and a second battery having a second module voltage. The battery management unit may be configured to close a module switch corresponding to the first battery, and to immediately close a module switch corresponding to the second battery without charging or discharging the first battery when a difference between the first module voltage and the second module voltage is smaller than a threshold value.

The power conversion apparatuses may include a bidirectional converter configured to provide the battery system with electric power received from at least one of the electric power generator and the grid system in the charge mode, and may provide at least one of the load and the grid system with the electric power received from the battery system in the discharge mode. The battery management unit may be configured to determine maximum charge allowable current and maximum discharge allowable current based on a number of batteries actually coupled in parallel, and may provide the bidirectional converter with information about the maximum charge allowable current and the maximum discharge allowable current. The bidirectional converter may be configured to provide the battery system with current that is smaller than the maximum charge allowable current in the charge mode, and may receive current that is smaller than the maximum discharge allowable current from the battery system in the discharge mode.

The energy storage system may further include module management units, and battery modules configured to be selectively coupled in parallel. Each of the battery modules may include: a battery from among the plurality of batteries; a module switch from among the module switches coupled in series to the battery; and a module management unit from among the module management units, the module management unit being configured to detect the module voltage of the battery, and to control closing and opening of the module switch.

The battery management unit may include the module management units and a main management unit coupled and configured to communicate with each other. The main management unit may be configured to receive the module voltages of the batteries from the module management units, and may be configured to transmit control commands to control the module switches to the module management units. The module management units may be configured to receive the control commands from the main management unit, and may be configured to close or open the module switches according to the control commands.

According to an embodiment of the present invention, a method of operating a battery pack including battery modules configured to be selectively coupled in parallel includes: measuring a module voltage of each of the battery modules; determining an operation mode of the battery pack; coupling the battery modules in parallel in an ascending order of the module voltage when the operation mode is a charge mode; and coupling the battery modules in parallel in a descending order of the module voltage when the operation mode is a discharge mode.

The battery modules may include a first battery module having a first module voltage, and a second battery module having a second module voltage that is greater than the first module voltage. The coupling the battery modules in parallel in the ascending order of the module voltage may include: charging the first battery module; coupling the second battery module to the first battery module in parallel when the first module voltage of the first battery module increases, and the first module voltage of the first battery module becomes substantially the same as the second module voltage of the second battery module; and charging the first battery module and the second battery module in parallel. The coupling the battery modules in parallel in the descending order of the module voltage may include: discharging the second battery module; coupling the first battery module to the second battery module in parallel when the second module voltage of the second battery module decreases, and the second module voltage of the second battery module becomes substantially the same as the first module voltage of the first battery module; and discharging the second battery module and the first battery module in parallel.

The battery modules may include a first battery module having a first module voltage, and a second battery module having a second module voltage that is higher than the first module voltage by a value that is smaller than a threshold value. The coupling the battery modules in parallel in the ascending order of the module voltage may include: coupling the first battery module; coupling the second battery module to the first battery module in parallel without charging the first battery module; and charging the first battery module and the second battery module in parallel. The coupling the battery modules in parallel in the descending order of the module voltage may include: coupling the second battery module; coupling the first battery module to the second battery module in parallel without discharging the second battery module; and discharging the second battery module and the first battery module in parallel.

The method may further include: determining maximum charge allowable current and maximum discharge allowable current based on a number of batteries coupled in parallel whenever the battery modules are coupled in parallel; and providing information about the maximum charge allowable current and the maximum discharge allowable current to an external apparatus.

### BRIEF DESCRIPTION OF THE DRAWINGS

These and/or other aspects of embodiments of the present invention will become apparent and appreciated by those having ordinary skill in the art from the following description of the embodiments, taken in conjunction with the accompanying drawings in which:

FIG. 1 is a schematic block diagram of a battery pack according to an embodiment of the present invention;

FIG. 2 is a schematic block diagram of a battery pack according to another embodiment of the present invention;

FIG. 3 is a schematic block diagram of an energy storage system coupled to an electric power generator, a grid system, and a load, according to an embodiment of the present invention;

FIG. 4 is a block diagram of a schematic structure of an energy storage system according to an embodiment of the present invention; and

FIG. 5 is a block diagram of a schematic structure of a battery system according to another embodiment of the present invention.

### DETAILED DESCRIPTION

Reference will now be made in detail to example embodiments of the present invention, examples of which are illustrated in the accompanying drawings, wherein like reference numerals refer to like elements throughout. In this regard, the present embodiments described herein may have various forms and should not be construed as being limited to the descriptions set forth herein. Accordingly, the embodiments are described below as examples only, by referring to the figures, to explain aspects of the embodiments of the present invention. As used herein, the term “and/or” includes any and all combinations of one or more of the associated listed items. Expressions such as “at least one of,” when preceding a list of elements, modify the entire list of elements and do not modify the individual elements of the list.

It will be understood by a person of ordinary skill in the art that, although the terms ‘first’ and ‘second’ are used herein to describe various elements, these elements should not be limited by these terms. Instead, these terms are only used to distinguish one element from another element. It will be further understood by a person of ordinary skill in the art that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the singular forms “a”, “an” and “the” are intended to include the plural forms as well, unless the context clearly indicates otherwise.

Hereinafter, aspects of embodiments of the present invention will be described with reference to the attached drawings. Like reference numerals in the drawings denote like elements, and thus, their description will not be repeated.

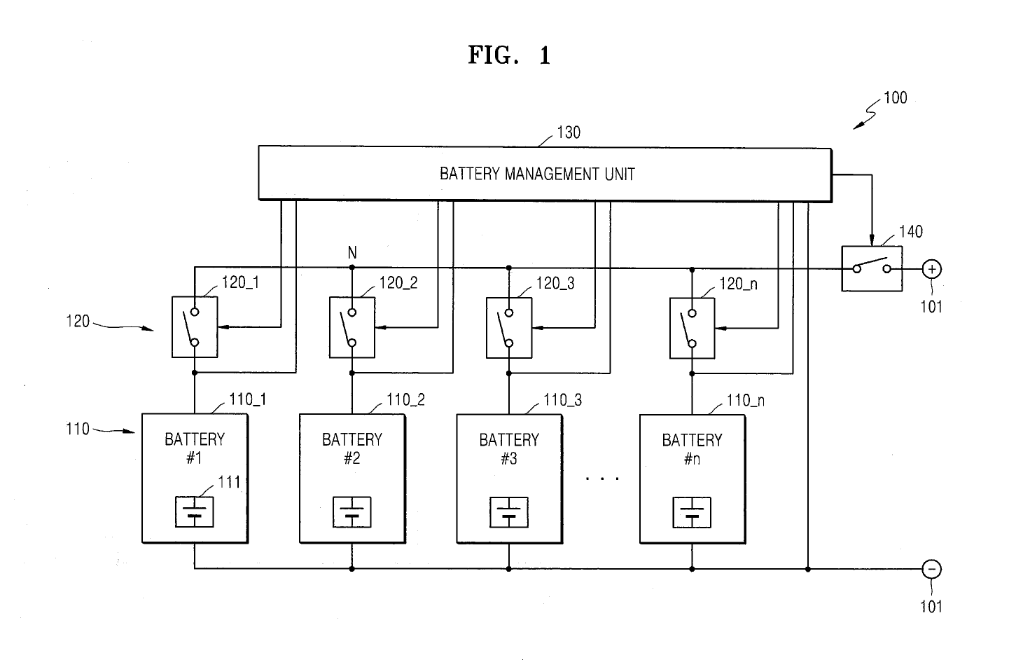

FIG. 1 is a schematic block diagram of a battery pack 100 according to an embodiment of the present invention.

Referring to FIG. 1, the battery pack 100 includes batteries 110_1 through 110_{—}n, module switches 120_1 through 120_{—}n, and a battery management unit 130. The batteries 110_1 through 110_{—}n are collectively referred to as the batteries 110, and the module switches 120_1 through 120_{—}n are collectively referred to as the module switches 120. Each of the module switches 120 is coupled to (e.g., connected to) a corresponding one of the batteries 110 in series. For example, a first battery 110_1 is coupled in series to a first module switch 120_1. The number of the batteries 110 may be the same as that of the number of the module switches 120.

The batteries 110 store electric power, and include at least one battery cell 111. In FIG. 1, each of the batteries 110 includes one battery cell 111, but embodiments of the present invention are not limited thereto, and each of the batteries 110 may include a plurality of battery cells 111. The battery cells 111 may be coupled to each other in series, in parallel, or in series and in parallel. The number of battery cells 111 included in the batteries 110 may be determined according to a required output voltage.

The batteries 110 may be selectively coupled in parallel, and may be coupled to a load and/or a charging device via main terminals 101. The main terminals 101 may be coupled to a bidirectional converter, and the battery pack 100 may provide electric power to the load, or may receive the electric power from the charging device via the bidirectional converter.

Each of the battery cells 111 may include a rechargeable secondary battery. For example, the battery cells 111 may include a nickel-cadmium battery, a lead storage battery, a nickel metal hydride (NiMH) battery, a lithium ion battery, a lithium polymer battery, and/or the like.

The batteries 110 may be selectively coupled in parallel through the module switches 120. That is, the batteries 110 may be selectively coupled to a node N via the module switches 120. The expression “selectively coupled” (e.g., selectively connected) refers to a connection or a disconnection by a switch or a similar device when a control signal (e.g., external control signal) is received. As illustrated in FIG. 1, when the module switches 120 are closed, the batteries 110 are electrically coupled (e.g., electrically connected) in parallel to each other, and when the module switches 120 are opened, the batteries 110 are not electrically coupled to each other in parallel. That is, when the module switches 120 are closed, the corresponding batteries 110 are electrically coupled to the node N, and when the module switches 120 are opened, the corresponding batteries 110 are electrically separated from the node N.

A battery management unit 130 detects a battery voltage of each of the batteries 110. The battery voltage of each of the batteries 110 is a voltage between a positive terminal and a negative terminal of each of the batteries 110. When the batteries 110 constitute battery modules, the above-mentioned battery voltage may be referred to as a module voltage. The battery management unit 130 may be coupled to terminals of the batteries 110 (for example, positive electrodes of the batteries 110) via wirings to detect the battery voltage of the batteries 110. For example, as illustrated in FIG. 1, the negative electrode of one of the batteries 110 is coupled to the negative main terminal 101. When the positive electrodes of the batteries 110 are respectively coupled to the module switches 120, the battery management unit 130 may be coupled to the negative main terminal 101 and the positive electrodes of the batteries 110 via the wirings.

According to another embodiment, the battery management unit 130 may include battery voltage detection units for detecting the battery voltage of the batteries 110. The battery voltage detection units may include an analog-digital converter ADC coupled to the positive electrodes of the batteries 110. The analog-digital converter ADC may convert the battery voltage of the batteries 110 into digital signals.

The battery management unit 130 may periodically detect the battery voltage of the batteries 110. For example, the battery management unit 130 may detect the battery voltage of each of batteries 110 at regular intervals (e.g., at predetermined cycles, for example, 100 ms cycles). The battery management unit 130 may detect a battery voltage of one of the batteries 110 that are electrically coupled (e.g., connected) in parallel, because the batteries 110 have the same battery voltage due to the parallel connection.

The battery management unit 130 may determine a connection order of the batteries 110 according to (e.g., based on) an operation mode of the battery pack 100 and the battery voltage of the batteries 110. The operation mode of the battery pack 100 may be a charge mode or a discharge mode. The charge mode is a mode where current flows into the battery pack 100 from a charging device, and the discharge mode is a mode where current flows from the battery pack 100 to the load. For example, the battery management unit 130 may determine a charge or a discharge of the battery pack 100 based on the battery voltage and/or a state of charge (SOC).

According to another embodiment, the battery management unit 130 may determine the operation mode of the battery pack 100 based on a command signal transmitted from the charging device coupled to the battery pack 100. For example, the charging device may be the bidirectional converter coupled to the battery pack 100, and the command signal for controlling the operation mode of the battery pack 100 may be received from the bidirectional converter, or from an integrated controller coupled to the bidirectional controller.

The battery management unit 130 may control the module switches 120 in order to couple the batteries 110 in parallel, according to the determined connection order. For example, the battery management unit 130 may control the module switches 120 by directly applying the control signal to the module switches 120. In another embodiment, the battery management unit 130 transmits a control command for controlling the closing and opening of the module switches 120, and a controller receiving the control command may close or open the module switches 120 according to the control command. The module switches 120 may be formed of switches, for example, relay switches, or field effect transistor (FET) switches.

In the charge mode, the battery management unit 130 may be configured to control the module switches 120 to couple the batteries 110 in parallel in an ascending order of the battery voltage from the battery 110 having the lowest battery voltage to the battery 110 having the highest battery voltage.

For example, assume that the battery voltage of the first battery 110_1 is the lowest, the battery voltage of the second battery 110_2 is the second lowest, the battery voltage of the third battery 110_3 is the third lowest, and the battery voltage of the n^{th} battery 110_{—}n is the highest. The battery management unit 130 may close the first module switch 120_1 corresponding to the first battery 110_1having the lowest battery voltage. The battery management unit 130 may charge the first battery 110_1. Due to the charge, the battery voltage of the first battery 110_1 gradually increases. When the battery voltage of the first battery 110_1 is substantially the same as that of the second battery 110_2 having the second lowest battery voltage, the battery management unit 130 may close the second module switch 120_2 corresponding to the second battery 110_2. The battery management unit 130 may charge both of the first and second batteries 110_1 and 110_2 that are coupled in parallel. Due to the charge, the battery voltage of the first and second batteries 110_1 and 110_2 gradually increases. When the battery voltage of the first and second batteries 110_1 and 110_2 is substantially the same as that of the third battery 110_3 having the third lowest battery voltage, the battery management unit 130 may close the third module switch 120_3 corresponding to the third battery 110_3. The battery management unit 130 may charge the first through third batteries 110_1 through 110_3 that are electrically coupled in parallel.

According to the above-described method, the battery management unit 130 may close all the module switches 120 by finally closing the n^{th} module switch120_{—}n corresponding to the n^{th} battery 110_{—}n having the highest battery voltage. The battery management unit 130 may charge or discharge the batteries 110 that are electrically coupled to each other.

In the discharge mode, the battery management unit 130 may be configured to control the module switches 120 to couple the batteries 110 in parallel in a descending order of the battery voltage from the battery 110 having the highest battery voltage to the battery 110 having the lowest battery voltage.

For example, assume that the battery voltage of the first battery 110_1 is the highest, the battery voltage of the second battery 110_2 is the second highest, the battery voltage of the third battery 110_3 is the third highest, and the battery voltage of the n^{th} battery 110_{—}n is the lowest. The battery management unit 130 may close the first module switch 120_1 corresponding to the first battery 110_1 having the highest battery voltage. The battery management unit 130 may discharge the first battery 110_1. Due to the discharge, the battery voltage of the first battery 110_1 gradually decreases. When the battery voltage of the first battery 110_1 is substantially the same as that of the second battery 110_2 having the second highest battery voltage, the battery management unit 130 may close the second module switch 120_2 corresponding to the second battery 110_2. The battery management unit 130 may discharge both of the first and second batteries 110_1 and 110_2 that are electrically coupled in parallel. The battery voltage of the first and second batteries 110_1 and 110_2 gradually decreases due to the discharge.

When the battery voltages of the discharged first and second batteries 110_1 and 110_2 are substantially the same as that of the third battery 110_3 having the third highest battery voltage, the battery management unit 130 may close the third module switch 120_3 corresponding to the third battery 110_3. The battery management unit 130 may discharge the first through third batteries 110_1 through 110_3 that are electrically coupled in parallel.

According to the above-described method, the battery management unit 130 may close all the module switches 120 by finally closing the n^{th} module switch 120_{—}n corresponding to the n^{th} battery 110_{—}n having the lowest battery voltage. The battery management unit 130 may charge or discharge the batteries 110 that are electrically coupled to each other.

Throughout the specification, the expression “a first value is substantially the same as a second value” may include a case where the first value is exactly the same as the second value as well as a case where a difference between the first value and the second value is smaller than a threshold value (e.g., a predetermined threshold value). For example, the expression that the battery voltage of the first battery 110_1 and that of the second battery 110_2 are substantially the same means that a difference between the battery voltage of the first battery 110_1 and that of the second battery 110_2 is smaller than the threshold value. The threshold value, for example, may be previously set in a range from 1% to 5% of the battery voltage of the batteries 110. For example, the threshold value may be 1V.

For example, when the first battery 110_1 has the lowest battery voltage and the second battery 110_2 has the second lowest battery voltage, the battery management unit 130 may charge the first battery 110_1 by closing the first module switch 120_1 in the charge mode. When the difference between the battery voltage of the first battery 110_1 and that of the second battery 110_2 is smaller than the threshold value as the battery voltage of the first battery 110_1 increases, the battery management unit 130 may be configured to concurrently (e.g., simultaneously) charge the first and second batteries 110_1 and 110_2 by closing the second module switch 120_2. According to the above-described method, the battery management unit 130 may be configured to couple all the batteries 110 in parallel by closing all the module switches 120.

As another example, when the first battery has the highest battery voltage and the second battery 110_2 has the second highest battery voltage, the battery management unit 130 may discharge the first battery 110_1 by closing the first module switch 120_1 in the discharge mode. When the difference between the battery voltage of the first battery 110_1 and that of the second battery 110_2 is smaller than the threshold value as the battery voltage of the first battery 110_1 decreases, the battery management unit 130 may be configured to concurrently (e.g., simultaneously) discharge the first and second batteries 110_1 and 110_2 by closing the second module switch 1202. According to the above-described method, the battery management unit 130 may be configured to couple all the batteries 110 in parallel by closing all the module switches 120.

According to another embodiment, when the first and second batteries 110_1 and 110_2 are coupled in parallel by closing the first and second module switches 120_1 and 120_2, and the third module switch 120_3 is opened, the battery management unit 130 charges or discharges the first and second batteries 110_1 and 110_2. As a result, when a difference between the battery voltage of the first and second batteries 110_1 and 110_2 and that of the third battery 110_3 is smaller than the threshold value, the battery management unit 130 may be configured to couple all the batteries 110 in parallel by closing the third module switch 120_3. According to the above-described method, the battery management unit 130 may be configured to couple all the batteries 110 in parallel.

According to another embodiment, when the first battery 110_1 has a first battery voltage, the second battery 110_2 has a second battery voltage, and the difference between the first battery voltage and the second battery voltage is smaller than the threshold value, the battery management unit 130 may be configured to sequentially or concurrently (e.g., simultaneously) close the first and second module switches 120_1 and 120_2. For example, the battery management unit 130 may be configured to close the second module switch 120_2, without charging or discharging the first battery 110_1, right after closing the first module switch 120_1. Therefore, when a difference in the battery voltage of some of the batteries 110 is smaller than the threshold value, the battery management unit 130 may couple some of the batteries 110 in parallel at a time (e.g., at a substantially same time), and thus a time taken to couple all the batteries 110 in parallel may be reduced.

The battery pack 100 may further include a main switch 140 coupled (e.g., interposed) between the batteries 110 and the main terminals 101. The main switch 140 may be formed of, for example, a relay via which current having a large value may flow, and by which a flow of the current may be controlled. In FIG. 1, the main switch 140 is coupled between the positive electrodes (that is, the node N) of the batteries 110 and the positive main terminal 101, but embodiments of the present invention are not limited thereto, and the main switch 140 may be coupled between the negative electrodes of the batteries 110 and the negative main terminal 101 instead. The battery management unit 130 may control the closing and opening of the main switch 140. The battery management unit 130 may be configured to control the main switch 140 such that when the main switch 140 is in an open state, the module switches 120 are switched from the open state to the closed state. That is, at a time when one of the batteries 110 is newly coupled in parallel, the main switch 140 may be in the open state. Accordingly, the charging device and/or the load coupled to the main terminals 101 may be protected from the inrush current resulting from new connection of the battery 120.

In another embodiment, when the main switch 140 is in the closed state, the batteries 110 may be newly coupled in parallel. When the battery voltages of the batteries 110 already coupled in parallel are substantially the same as that of the battery 110 to be newly coupled, the battery management unit 130 closes the module switch 120 corresponding to the battery 110 to be newly coupled. Thus, little or no inrush current is generated, and the charging device and/or the load coupled to the main terminals 101 may not be damaged.

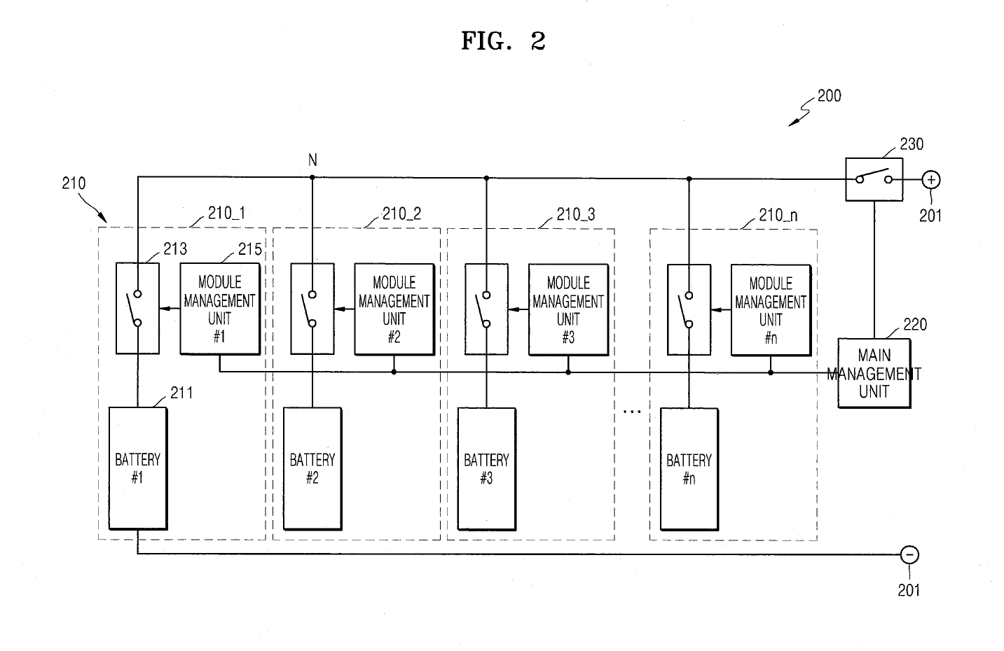

FIG. 2 is a schematic block diagram of a battery pack 200 according to another embodiment of the present invention.

Referring to FIG. 2, the battery pack 200 includes battery modules 210_1 through 210_{—}n that are selectively connected in parallel, a main management unit 220, and a main switch 230. The battery modules 210_1 through 210_{—}n are collectively referred to as the battery modules 210. Each of the battery modules 210 includes a battery 211 and a module switch 213 that are connected in series. Each of the battery modules 210 further includes a module management unit 215 for measuring a module voltage of the battery 211 and controlling close and open of the module switch 213. The battery pack 200 may be referred to as a battery system.

As illustrated in FIG. 2, the batteries 211 may be selectively coupled (e.g., connected) in parallel by the module switches 213. That is, one of the batteries 211 may be selectively coupled to a node N through a corresponding one of the module switches 213. At a time when the batteries 211 having different voltages are electrically coupled in parallel, inrush current may be generated. In the embodiment shown in FIG. 2, when the module voltages of the batteries 211 are substantially the same, that is, when a difference between the module voltages of the batteries 211 is smaller than a threshold value, the batteries 211 are coupled in parallel, and thus, little or no inrush current may be generated.

In the embodiment shown in FIG. 2, a battery 211 having a higher module voltage than the others may be discharged, or a battery 211 having a smaller module voltage than the others may be charged, in order to make the module voltages of the batteries 211 substantially the same. In a process of making the module voltage substantially the same, the main management unit 220 controls the module switches 213 to electrically couple the batteries 211 in parallel in an ascending order of the module voltage from the battery 211 having the lowest module voltage to the battery 211 having the highest module voltage in a charge mode. Also, the main management unit 220 controls the module switches 213 to couple the batteries 211 in parallel in a descending order of the module voltage from the battery 211 having the highest module voltage to the battery 211 having the lowest module voltage in a discharge mode. While the module voltage of the battery 211 having the highest module voltage decreases to that of the battery 211 having the lowest module voltage, electrical energy discharged from the battery 211 having the highest module voltage is used in load.

The batteries 211 and the module switches 213, respectively, operate in a substantially same manner as the batteries 110 and the module switches 120 shown in FIG. 1 and described above, and thus, the descriptions thereof have been omitted. Both the main management unit 220 and the module management units 215 are substantially same as the battery management unit 130 shown in FIG. 1. That is, the battery management unit 130 of FIG. 1 may include the main management unit 220 and the module management units 215 that are coupled to intercommunicate with the main management unit 220.

The main management unit 220 and the module management units 215 may be coupled to each other (e.g., interconnected) via a communication bus. For example, a controller area network (CAN) communication may be used as a communication protocol for a communication of the main management unit 220 and the module management units 215. However, the communication protocol is not limited thereto, and any communication protocol that transmits data or commands through a communication bus may be used. The main management unit 220 may be referred to as a rack battery management system (BMS), and each of the module management units 215 may be referred to as a module BMS or a tray BMS.

Each of the module management units 215 measures the module voltage of the corresponding battery 211, and the measured module voltage may be transmitted to the main management unit 220. The main management unit 220 may receive the module voltages of the batteries 211 from the module management units 215 to collect the module voltages of all the battery modules 210. The main management unit 220 may determine an operation mode of the battery pack 200. The operation mode may be a charge mode or a discharge mode. For example, the main management unit 220 determines a SOC based on the module voltages of the battery modules 210, and the main management unit 220 may determine the operation mode of the battery pack 200 by comparing the SOC with a reference value (e.g., a predetermined reference value). For example, the reference value may be 50%. When the SOC of the battery modules 210 (for example, an average SOC, or a maximum SOC) is less than 50%, the main management unit 220 may determine the operation mode of the battery pack 200 as the charge mode. When the SOC of the battery modules 210 (for example, an average SOC, or a minimum SOC) is greater than 50%, the main management unit 220 may determine the operation mode of the battery pack 200 as the discharge mode.

According to another embodiment, the main management unit 220 requests a command for the operation mode of the battery pack 200 to an external device (for example, an integrated controller, a bidirectional converter, or charge/discharge device) coupled to communicate with the main management unit 220. Also, the external device may determine the operation mode of the battery pack 200 by evaluating states of a load coupled to the battery pack 200, a commercial power supply, and a power generator, and the main management unit 200 may receive the command about the determined operation mode from the external device.

Each of the module management units 215 measures the module voltage of the corresponding battery 211, as well as a cell voltage of at least one battery cell in the corresponding battery 211, and may transmit the measured cell voltage to the main management unit 220. Also, Each of the module management unit 215 measures temperature of the corresponding battery 211 and/or charge and discharge current thereof, and may transmit the measured temperature and/or the measured charge and discharge current to the main management unit 220. Each of the module management units 215 may include a temperature sensor and a current sensor in order to measure the temperature and/or the charge and discharge current, or may be coupled to the temperature sensor and the current sensor. The main management unit 220 may collect parameters (for example, the cell voltage, charge and discharge current, and temperature) of the batteries 211, and may determine the state of charge (SOC) and/or a state of health (SOH) of the batteries 211.

Each of the module management unit 215 may control the corresponding module switch 213. Each of the module management units 215 may be configured to close or open the corresponding module switch 213. The module switch 213 may be formed of a relay or a FET. Each of the module management units 215 may control the corresponding module switch 213 according to a control command transmitted by the main management unit 220.

The main management unit 220 may collect the module voltages of the batteries 211 from the module management units 215, and may determine an order for coupling (e.g., connecting) the batteries 211 in parallel according to the operation mode (for example, the charge mode or the discharge mode). As described above, in the charge mode, the main management unit 220 may determine the order for coupling the batteries 211 as an ascending order of the module voltage. In the discharge mode, the main management unit 220 may determine the order for coupling the batteries 211 as a descending order of the module voltage.

For example, assuming that the first battery module 210_1 has the lowest module voltage in the charge mode, or the first battery module 210_1 has the highest module voltage in the discharge mode, the main management unit 220 may transmit a control command for closing the module switch 213 of the first battery module 210_1 to the module management unit 215 of the first battery module 210_1 according to the determined order. The module management units 215 of the first battery module 210_1 receives the control command, and by closing the module switch 213 of the first battery module 210_1 according to the control command, the battery 211 of the first battery module 210_1 may be coupled to the node N.

The main management unit 220 may close the main switch 230 after checking the closed state of the module switch 230 of the first battery module 210_1, and then may charge or discharge the battery 211 of the first battery module 210_1 according to the operation mode. As described above, each of the module management units 215 may periodically measure the module voltage of the corresponding battery modules 210, and may periodically transmit the measured module voltage to the main management unit 220. The module voltage of the first battery module 210_1 may change (for example, increase or decrease) according to the charge or discharge. When the module voltage of the first battery module 210_1 becomes substantially the same as that of the second battery module 210_2, under the assumption that the second battery module 210_2 has the second lowest module voltage in the charge mode or the second battery module 210_2 has the second highest module voltage in the discharge mode, the main management unit 220 may transmit the control command for closing the module switch 213 of the second battery module 210_2 to the module management unit 215 of the second battery module 210_2. The module management unit 215 of the second battery module 210_2 closes the module switch 213 of the second battery module 210_2 according to the control command, and thus, the battery 211 of the second battery module 210_2 may be electrically coupled to the node N. According to the above-described method, all the module switches 213 may be closed, and all the battery modules 210 may be coupled in parallel. The main management unit 220 closes the main switch 230, and all the battery modules 210 may be charged or discharged according to the state of the load and/or the power supply, such as the commercial power supply, and the power generator.

Hereinafter, a method of operating the battery pack 200 will be described. Before operating the battery pack 200, the module switches 213 and the main switches 230 are opened, and the main management unit 220 and the module management units 215 are turned off.

First, the main management unit 220 and the module management units 215 are turned on. The module management units 215 may be turned on under a control of the main management unit 220.

Each of the module management units 215 measures the module voltage of the corresponding battery 211, and transmits the measured module voltage to the main management unit 220. The module management units 215 may periodically measure the module voltage, and may keep transmitting the measured module voltage to the main management unit 220.

The main management unit 220 may determine the operation mode of the battery pack 200. The operation mode may be one of the charge mode and the discharge mode. According to an embodiment, the main management unit 220 may determine the charge and the discharge of the batteries 211 of the battery modules 210 based on the module voltages of the battery modules 210 transmitted by the module management units 215. According to another embodiment, the main management unit 220 may determine the operation mode of the battery pack 200 based on the state of the load and/or the power supply coupled (e.g., connected) to the main terminals 201 of the battery pack 200. According to yet another embodiment, the main management unit 220 may receive a command for the operation mode of battery pack 200 from an integrated controller of an energy storage system.

When the operation mode is the charge mode, the main management unit 220 may couple the battery modules 210 according to an ascending order of the module voltage. When the operation mode is the discharge mode, the main management unit 220 may couple the battery modules 210 in a descending order of the module voltage.

For example, a case where the operation mode is the charge mode will be explained. It is assumed that the module voltage of the first battery module 210_1 is the lowest, that of the second battery module 210_2 is the second lowest, and that of the third battery module 210_3 is the third lowest. Further, it is assumed that the module voltage of the n^{th} battery module 210_{—}n is the highest. In the charge mode, the main management unit 220 may couple the battery modules 210 in parallel in the ascending order of the module voltage from the first battery module 210_1 to the n^{th} battery module 210_{—}n.

The main management unit 220 may transmit a control command to the module management unit 215 of the first battery module 210_1 in order to close the module switch 213 of the first battery module 210_1. The module management unit 215 of the first battery module 210_1 receives the control command, and may close the module switch 213 of the first battery module 210_1. The main management unit 220 may close the main switch 230 after checking the closed state of the module switch 213 of the first battery module 210_1.

The main management unit 220 may charge the battery 213 of the first battery module 210_1. Thus, the module voltage of the first battery module 210_1 increases. The module management unit 215 of the first battery module 210_1 transmits the module voltage thereof to the main management unit 220, and the main management unit 220 may wait until the module voltage of the first battery module 210_1 becomes substantially the same as that of the second battery module 210_2.

When the module voltage of the first battery module 210_1 is substantially the same as that of the second battery module 210_2, the main management unit 220 may prepare to couple the second battery module 210_2 to the node N. The main management unit 220 may open the main switch 230. According to another embodiment, the main management unit 220 may not open the main switch 230.

The main management unit 220 may transmit a control command to the module management unit 215 of the second battery module 210_2 in order to close the module switch 213 of the second battery module 210_2. The module management unit 215 of the second battery module 210_2 may receive the control command and may close the module switch 213 of the second battery module 210_2. After checking the closed state of the module switch 213 of the second battery module 210_2, the main management unit 220 may close the main switch 230.

The main management unit 220 may charge the batteries 211 of the first battery module 210_1 and the second battery module 210_2 that are electrically coupled in parallel. Thus, the module voltages of the first and second battery modules 210_1 and 210_2 increase. At least one of the module management units 215 of the first battery module 210_1 and the second battery module 210_2 transmits at least one of the module voltages of the first and second battery module 210_1 and 210_2 to the main management unit 220. The main management unit 220 may wait until the module voltages of the first and second battery modules 210_1 and 210_2 become substantially the same as the module voltage of the third battery module 210_3.

When the module voltages of the first and second battery modules 210_1 and 210_2 are substantially the same as the module voltage of the third battery module 210_3, the main management unit 220 may newly couple the third battery module 210_2 to the first and second battery modules 210_1 and 210_2. According to this method, the main management unit 220 may couple all the battery modules 210 in parallel.

When the operation mode is the discharge mode, the method of connecting the batteries for discharging the battery modules 210 is substantially the same as the above-described method of connecting the batteries for charging the battery modules 210, except the connection order of the battery modules 210 in the discharge mode when compared to the charge mode.

When the module voltages of the second battery module 210_2 and the third battery module 210_3 are substantially the same, that is, when a difference between the module voltages of the second battery module 210_2 and the third battery module 210_3 is smaller than a threshold value, the main management unit 220 couples the second battery module 210_2 to the first battery module 210_1, and then couples the third battery module 210_3 to the first battery module 210_1, without charging or discharging the batteries 211 of the first and second battery modules 210_1 and 210_2.

When the first battery module 210_1 is replaced in the battery pack 200 being operated, the module voltages of the second through n^{th} battery modules 210_2 through 210_{—}n may be substantially the same, but the module voltage of the first battery module 210_1 may be different. When the battery pack 200 operates, the main management unit 220 may concurrently (e.g., simultaneously) couple the second through the n^{th} battery modules 210_2 through 210_{—}n in parallel. For example, the main management unit 220 may sequentially couple the second through the n^{th} battery modules 210_2 through 210_{—}n, without charging or discharging the second through the n^{th} battery modules 210_2 through 210_{—}n while coupling the second through n^{th} battery modules 210_1 through 210_{—}n. Then, when the module voltages of the second through n^{th} battery modules 210_2 through 210_{—}n are substantially the same as the module voltage of the first battery module 210_1 by charging or discharging the second through the n^{th} battery modules 210_2 through 210_{—}n, the main management unit 220 may finally couple the first battery module 210_1 to the second through n^{th} battery modules 210_2 through 210_{—}n in parallel.

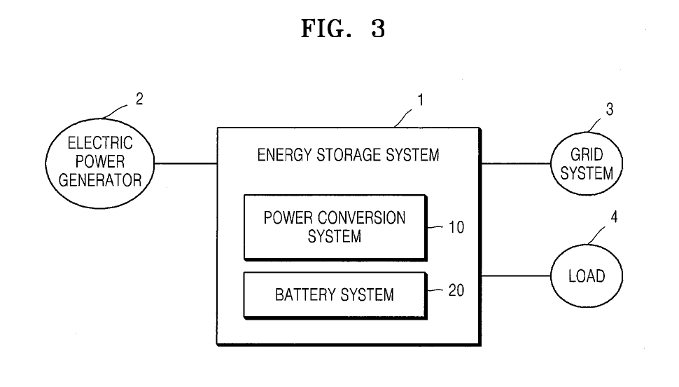

FIG. 3 is a schematic block diagram of an energy storage system 1 coupled to an electric power generator, a grid system, and a load, according to an embodiment of the present invention.

Referring to FIG. 3, the energy storage system 1 is coupled to (e.g., connected to) an electric power generator 2, a grid system 3, and/or a load 4. The energy storage system 1 includes a battery system 20 for storing the electric power and a power conversion system (PCS) 10. The PCS 10 converts the electric power provided by the electric power generator 2, the grid system 3, and/or the battery system 20 into electric power with an appropriate form, and may supply the converted electric power to the load 4, the battery system 20, and/or the grid system 3.

The electric power generator 2 is a system for generating the electric power from energy sources. The electric power generator 2 may provide the generated electric power to the energy storage system 1. The electric power generator 2 may include at least one of sunlight power generation, wind power generation, and tidal power generation. For example, the electric power generator 2 may include all electric power generators for generating the electric power by using new and renewable energy such as solar heat and geothermal heat. The electric power generator 2 may form a large-capacity energy system by arranging a variety of power generation modules that may generate the electric power.

The grid system 3 may include a power plant, a substation, power lines, etc. When the grid system 3 is in a normal state, the grid system 3 may provide the electric power to the load 4 and/or the battery system 20, or may receive the electric power from the battery system 20 and/or the electric power generator 2. When the grid system 3 is in an abnormal state, a power transmission between the grid system 3 and the energy storage system 1 may stop.

The load 4 may consume electric power generated by the electric power generator 2, electric power stored in the battery system 20, and/or electric power provided by the grid system 3. Examples of the load 4 may be electric apparatuses in households or factories in which the energy storage system 1 is installed.

The energy storage system 1 may store the electric power generated by the electric power generator 2 in the battery system 20, or may provide the electric power generated by the electric power generator 2 to the grid system 3. The energy storage system 1 may provide the electric power stored in the battery system 20 to the grid system 3, or may store the electric power provided by the grid system 3 in the battery system 20. Also, the energy storage system 1 may function as an uninterruptible power supply, and may provide the electric power generated by the electric power generator 2, or the electric power stored in the battery system 20, to the load 4 when the grid system 3 is in the abnormal state, for example, a blackout.

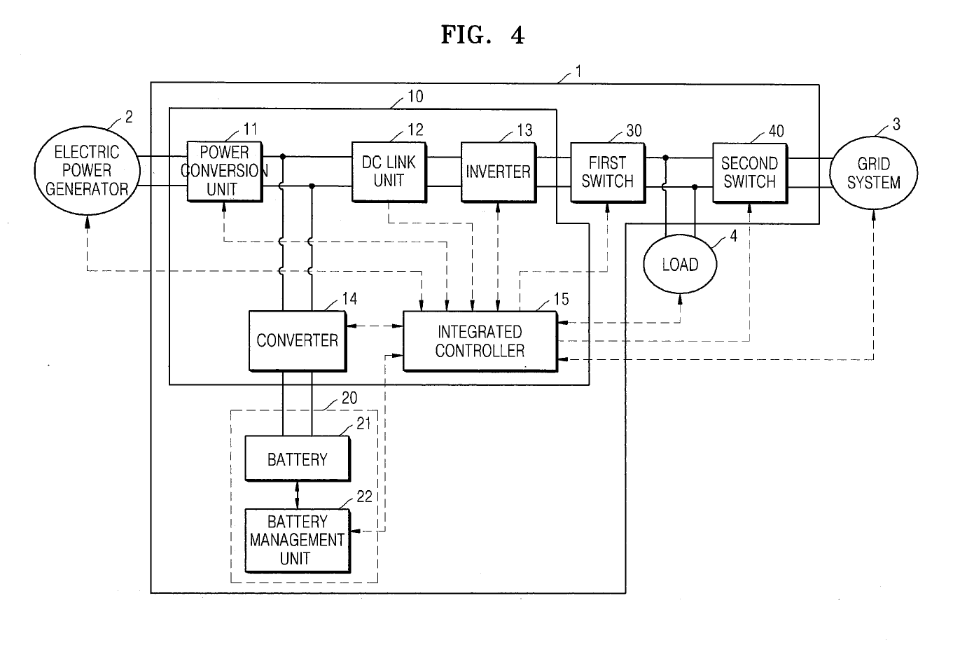

FIG. 4 is a block diagram of a schematic structure of the energy storage system 1 according to an embodiment of the present invention.

Referring to FIG. 4, the energy storage system 1 may include a PCS 10 configured to convert the electric power, the battery system 20, a first switch 30, and a second switch 40. The battery system 20 may include a battery 21 and a battery management unit 22.

The PCS 10 converts the electric power provided by the electric power generator 2, the grid system 3, and/or the battery system 20 into electric power with an appropriate form, and may provide the electric power to the load 4, the battery system 20 and/or the grid system 3. The PCS 10 may include a power conversion unit 11, a DC link unit 12, an inverter 13, a converter 14, and an integrated controller 15.

The power conversion unit 11 may be a power conversion apparatus coupled (e.g., connected) between the electric power generator 2 and the DC link unit 12. The power conversion unit 11 may convert the electric power generated by the electric power generator 2 into a DC link voltage, and may supply (e.g., transmit) the DC link voltage to the DC link unit 12. The power conversion unit 11 may include a power conversion circuit, such as a converter circuit, and a rectifier circuit according to types of the electric power generator 2. When the electric power generator 2 generates DC power, the power conversion unit 11 may include a DC-DC converter circuit for converting the DC power generated in the electric power generator 2 into another DC power. When the electric power generator 2 generates AC power, the power conversion unit 11 may include the rectifier circuit for converting the AC power generated in the electric power generator 2 into the DC power.

When the electric power generator 2 is a sunlight power generator, the power conversion unit 11 may include a maximum power point tracking (MPPT) converter for performing a MPPT control in order to acquire the electric power generated by the electric power generator 2. Also, when no electric power is generated by the electric power generator 2, an operation of the power conversion unit 11 stops, and the power consumed in the power conversion apparatus such as the converter circuit or the rectifier circuit may be decreased (e.g., minimized) or increased (e.g., maximized).

A level of the DC link voltage may be unstable due to an instantaneous voltage sag in the electric power generator 2 or the grid system 3, or an occurrence of a peak load in the load 4. However, the DC link voltage should be substantially stable for normal operations of the converter 14 and the inverter 13. The DC link unit 12 is disposed between the power conversion unit 11, the inverter 13, and the converter 14, and may maintain the DC link voltage at a constant level or a substantially constant level. The DC link unit 12 may include, for example, a large-capacity capacitor.

The inverter 13 may be a power conversion apparatus coupled between the DC link unit 12 and the first switch 30. The inverter 13 may include an inverter for converting the DC link provided by at least one of the electric power generator 2 and the battery system 20 into the AC power of the grid system 3, and outputting the same. Also, the inverter 13 may include the rectifier circuit for converting the AC power provided by the grid system 3 into the DC link power and outputting the converted DC link power in order to store the power of the grid system 3 in the battery system 20 during the charge mode. The inverter 13 may be a bidirectional inverter, wherein the input and output directions may be changed.

The inverter 13 may include a filter for removing higher harmonics from the AC power output to the grid system 3. Also, the inverter 13 may include a phase-locked loop (PLL) circuit for synchronizing a phase of the AC power output from the inverter 13 with a phase of the grid system 3, to control or to substantially limit an occurrence of reactive power. Also, the inverter 13 may perform functions such as a limit to a range of voltage fluctuation, improvement of a power factor, removal of DC components, and protection from or decrease of transient phenomena.

The converter 14 may be a power conversion apparatus coupled between the DC link unit 12 and the battery system 20. The converter 14 may include a DC-DC converter for DC-DC converting of the electric power stored in the battery system 20 into the DC link voltage on a DC-DC conversion basis, and outputting the DC link voltage to the inverter 13 during the discharge mode. Also, the converter 14 may include a DC-DC converter for DC-DC converting the DC link voltage output from the power conversion unit 11, and/or the DC link voltage output from the inverter 13 during the charge mode, into a DC voltage having an appropriate level of a voltage (for example, a charge voltage level required by the battery system 20), to output the converted DC link voltage to the battery system 20. The converter 14 may be a bidirectional converter wherein the input and output directions may change. When the battery system 20 is not charged or discharged, an operation of the converter 14 stops, and thus power consumption may be reduced or minimized.

The integrated controller 15 may monitor states of the electric power generator 2, the grid system 3, the battery system 20, and the load 4. For example, the integrated controller 15 may monitor a blackout state in the grid system 3, whether or not electric power is being generated in the electric power generator 2, the amount of the electric power generated in the electric power generator 2, a charge state of the battery system 20, the amount of the electric power consumed by the load 4, power consumption time of the load 4, etc.

The integrated controller 15 may control operations of the power conversion unit 11, the inverter 13, the converter 14, the battery system 20, the first switch 30, and the second switch 40 according to a monitoring result and an algorithm (e.g., a predetermined algorithm). For example, when a blackout occurs in the grid system 3, the integrated controller 15 may control the second switch 40 to provide the load 4 with the electric power stored in the battery system 20 or the electric power generated in the electric power generator 2. Also, when there is not enough electric power to be provided to the load 4, the integrated controller 15 may set a priority for the electrical apparatuses of the load 4, and may control the load 4 to first provide electric power to an electrical apparatus having a higher priority within the electrical apparatuses of the load 4. Also, the integrated controller 15 may control a charge and a discharge of the battery system 20.

The first and second switches 30 and 40 are coupled (e.g., connected) in series between the inverter 13 and the grid system 3, and may control a flow of current between the electric power generator 2 and the grid system 3 by performing close and open operations according to a control of the integrated controller 15. Closed and open states of the first and second switches 30 and 40 may be determined according to states of the electric power generator 2, the grid system 3, and the battery system 20. In particular, when the electric power is provided to the load from at least one of the electric power generator 2 and the battery system 20, or when the electric power from the grid system 3 is provided to the battery system 20, the first switch 30 may be in the closed state. When the electric power from at least one of the electric power generator 2 and the battery system 20 is provided to the grid system 3, or when the electric power from the grid system 3 is provided to at least one of the load 4 and the battery system 20, the second switch 40 may be in the closed state.

When a blackout occurs in the grid system 3, the second switch 40 is in the open state, and the first switch 30 may be in the closed state. That is, the electric power from at least one of the electric power generator 2 and the battery system 20 is provided to the load 4, and a flow of the electric power provided to the load 4 is prevented from being provided to the grid system 3 at substantially the same time. Similarly, by operating the energy storage system 1 as a stand-alone system, an electric shock accident that a worker who works around power lines of the grid system 3 receives an electric shock delivered from the electric power generator 2 or the battery system 20 may be substantially prevented.

The first and second switches 30 and 40 may include a switching device such as a relay for enduring or processing a large amount of current.

The battery system 20 receives electric power from at least one of the electric power generator 2 and the grid system 3 and stores the same. Furthermore, the battery system 20 may provide the stored electric power to at least one of the load 4 and the grid system 3. The battery system 20 may correspond to the battery packs 100 and 200 described with reference to FIGS. 1 and 2.

The battery system 20 may include a battery 21 including at least one battery cell to store electric power, and a battery management unit 22 for controlling and protecting the battery 21. The battery 21 may include sub-batteries that are selectively coupled in parallel. The sub-batteries may correspond to the batteries 110 and 211 described with reference to FIGS. 1 and 2. The battery management unit 22 may correspond to the battery management unit 130 described with reference to FIG. 1, and a combination of the module management units 215 and the main management unit 220 described with reference to FIG. 2. The battery 21 may include a plurality of battery racks or battery packs that are selectively coupled in parallel. In this embodiment, the battery racks or the battery packs may correspond to the sub-batteries. The battery 21 may be the battery racks or the battery packs including battery trays or battery modules that are selectively coupled in parallel, and in this embodiment, the battery trays or the battery modules may correspond to the sub-batteries. The battery 21 may be the battery trays or the battery modules including battery cells that are selectively coupled in parallel, and in this embodiment, the battery cells may correspond to the sub-batteries.

The battery management unit 22 may be coupled to the battery 21, and may control overall operations of the battery system 20, according to control commands or internal algorithms from the integrated controller 15. For example, the battery management unit 22 may perform an overcharge protection function, an over-discharge protection function, an overcurrent protection function, an overheat protection function, a cell balancing function, and/or the like.

The battery management unit 22 may obtain a voltage, current, temperature, amount of residual electric power, lifetime, SOC, etc. of the battery 21. For example, the battery management unit 22 may measure a cell voltage, current, and temperature of the battery 21 by using sensors. The battery management unit 22 may calculate the amount of the residual electric power, the lifetime, the SOC, etc. of the battery 21 based on the measured cell voltage, the measured current and the measured temperature. The battery management unit 22 may manage the battery 21 based on the measured and calculated results, and may transmit the measured and calculated results, etc. to the integrated controller 15. The battery management unit 22 may control charge and discharge operations of the battery 21 according to charge and discharge control commands received from the integrated controller 15.

The battery management unit 22 may detect a terminal voltage of each of the sub-batteries. The terminal voltage is a voltage between positive and negative electrodes of the sub-batteries. The battery management unit 22 may receive information about an operation mode of the battery system 20 (for example, a charge command or a discharge command). The battery management unit 22 may determine the operation mode of the battery system 20 based on the received information.

When the operation mode is the charge mode, the battery management unit 22 may couple the sub-batteries in parallel in an ascending order of the terminal voltage from a sub-battery having the lowest terminal voltage to a sub-battery having the highest terminal voltage. When the sub-batteries are additionally coupled, the battery management unit 22 may determine the maximum charge allowable current based on the number of sub-batteries being coupled in parallel. The battery management unit 22 may provide the integrated controller 15 with information about the maximum charge allowable current. The integrated controller 15 may control the converter 14 to charge current that is lower than the maximum charge allowable current to the converter 14. In another embodiment, the battery management unit 22 may provide the converter 14 with the information about the maximum charge allowable current, and the converter 14 may provide the battery 21 with the current that is lower than the maximum charge allowable current.

When the operation mode is the discharge mode, the battery management unit 22 may couple the sub-batteries in parallel in a descending order of the terminal voltage from a sub-battery having the highest terminal voltage to a sub-battery having the lowest terminal voltage. When the sub-batteries are additionally coupled, the battery management unit 22 may determine maximum discharge allowable current based on the number of sub-batteries coupled in parallel. The battery management unit 22 may provide the integrated controller 15 with information about the maximum discharge allowable current. The integrated controller 15 may control the converter 14 to discharge current that is lower than the maximum discharge allowable current from the battery 21. In another embodiment, the battery management unit 22 may provide the converter 14 with the information on the maximum discharge allowable current, and the converter 14 may extract the current that is lower than the maximum discharge allowable current from the battery 21.

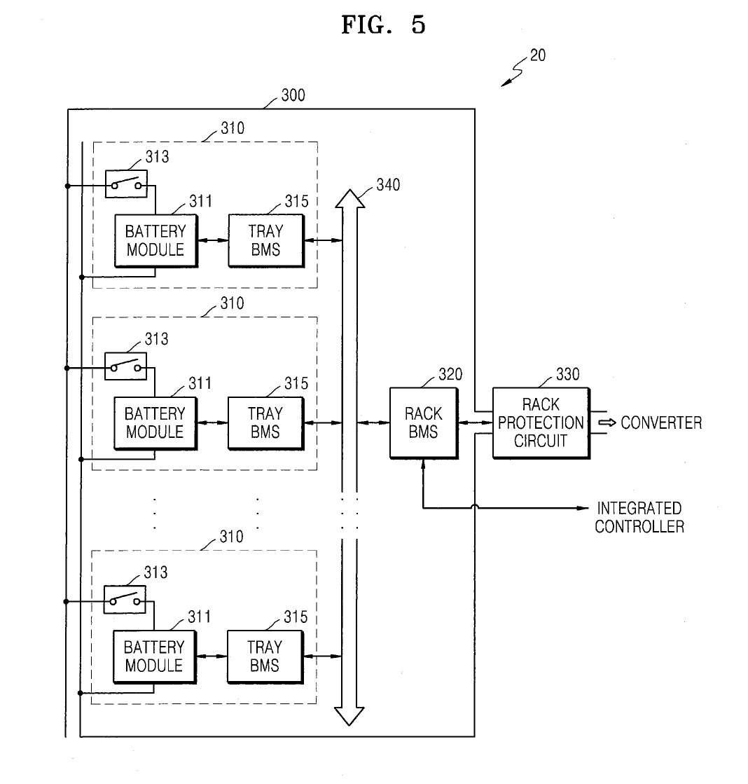

FIG. 5 is a block diagram of a schematic structure of the battery system 20 according to another embodiment of the present invention.

Referring to FIG. 5, the battery system 20 may include a battery rack 300 as a sub-component, and the battery rack 300 may include a tray 310 as a sub-component. The battery rack 300 may correspond to the battery packs 100 and 200 described with reference to FIGS. 1 and 2, and may be referred to as a battery pack.

The battery system 20 may include a rack management system (BMS) 320, trays 310, a rack protection circuit 330, and a bus line 340. The rack BMS 320 may correspond to the main management unit 220 described with reference to FIG. 2. The trays 310 may correspond to the battery modules 210 described with reference to FIG. 2. The rack protection circuit 330 may include the main switch 230 described with reference to FIG. 2.

The trays 310 store electric power as a sub-component of the battery rack 300, and may provide the stored electric power to the grid system 3 and/or the load 4. Each of the trays 310 may include a battery module 311, a tray switch 313, and a tray BMS 315. The battery module 311, the tray switch 313, and the tray BMS 315 may correspond to the battery 211, the module switch 213, and the module management unit 215 described with reference to FIG. 2, respectively.

The battery modules 311 store electric power and may include at least one battery cell. As illustrated in FIG. 5, the battery modules 311 may be selectively coupled in parallel. That is, when all of the module switches 213 are closed, all of the battery modules 311 are coupled in parallel. When all of the module switches 213 are opened, all of the battery modules 311 are not coupled in parallel.

The tray BMS 315 monitors states of the battery modules 311, for example, temperature, a cell voltage, charge current and discharge current, etc., and may transmit monitored values to the rack BMS 320. The tray BMS 315 receives a control signal from the rack BMS 320, and may perform operations according to the control signal.

The bus line 340 is a path disposed between the rack BMS 320 and the tray BMS 315, and may transmit data or commands. A CAN communication protocol may be used between the rack BMS 320 and the tray BMS 315. However, communication protocols are not limited thereto, and all communication protocols for transmitting data or commands by using a bus line may be used.

The rack BMS 320 couples the battery system 20 to the converter 14 by controlling the rack protection circuit 330, and may control charge and discharge operations of the battery system 20.

The rack protection circuit 330 may block electric power transmission according to a control of the rack BMS 320. For example, the rack protection circuit 330 may include a relay, a fuse, etc. for blocking current. The rack protection circuit 330 measures a voltage, current, etc. of the battery system 20, and may transmit a measured result to the rack BMS 320 or the integrated controller 15. For example, the rack protection circuit 330 may include a sensor for measuring a voltage, current, etc.

The tray BMSs 315 measure a tray voltage of corresponding battery modules 311, and may transmit the measured tray voltage to the rack BMS 320 through the bus line 340. The rack BMS 320 may collect the tray voltage of the battery trays 310. The rack BMS 320 may determine the operation mode of the battery rack 300 as, for example, the charge mode or the discharge mode according to, for example, a control of the integrated controller 15.

The rack BMS 320 may determine an order of coupling (e.g., connecting) the battery trays 310 in parallel based on the tray voltage and the operation mode (for example, the charge mode or the discharge mode) of the battery modules 311. In the case of the charge mode, the rack BMS 320 may couple the battery trays 310 in an ascending order of the tray voltage. In the case of the discharge mode, the rack BMS 320 may couple the battery trays 310 in a descending order of the tray voltage.

In the present embodiment, the battery system 20 including a battery rack 300 is described. However, according to a voltage or a capacity required by a consumer, battery racks 300 are coupled in parallel to form a battery system 20. When the battery system 20 includes the battery racks 300, the battery system 20 may further include a system BMS for controlling the battery racks 300. In this regard, the system BMS may correspond to the main management unit 220 described with reference to FIG. 2, and the rack BMSs 320 may correspond to the module management units 215 described with reference to FIG. 2.

The embodiments shown and described herein are illustrative examples of the invention only and are not intended to otherwise limit the scope of the invention in any way. For the sake of brevity, conventional electronics, control systems, software development and other functional aspects of the systems (and components of the individual operating components of the systems) may have been omitted. Furthermore, the connecting lines or connectors shown in the various figures presented are intended to represent examples of functional relationships and/or physical or logical couplings between the various elements. It should be noted that various alternative or additional functional relationships, physical connections or logical connections may be present in a practical device. Moreover, no item or component is essential to the practice of the invention, unless the element is specifically described as “essential” or “critical”. It will be recognized that the terms “comprising,” “including,” and “having,” as used herein, are intended to be read as open-ended terms of art.

The use of the terms “a” and “an” and “the,” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order, unless otherwise indicated herein, or otherwise clearly contradicted by context. The use of any and all examples, or exemplary language (e.g., “such as”) provided herein, is intended merely to better illuminate the invention, and does not pose a limitation on the scope of the invention unless otherwise claimed. Various modifications and adaptations will be readily apparent to those of ordinary skill in this art without departing from the spirit and scope of the invention.

It should be understood by a person having ordinary skill in the art that the embodiments described herein should be considered in a descriptive sense only and not for purposes of limitation. Descriptions of features or aspects within each embodiment should typically be considered as available for other similar features or aspects in other embodiments.

While aspects of the embodiments of the present invention have been described with reference to the accompanying drawings, it will be understood by those of ordinary skill in the art that various modifications in form and detail may be made therein, without departing from the spirit and scope of the present invention as defined by the following claims, and their equivalents.

What is claimed is:

1. A battery pack comprising:
a plurality of batteries configured to be selectively coupled in parallel through module switches; and
a battery management unit configured to:
detect a module voltage of each of the plurality of batteries;
control the module switches to couple the plurality of batteries in parallel in an ascending order of the module voltage from a battery having a lowest module voltage to a battery having a highest module voltage in a charge mode; and
control the module switches to couple the plurality of batteries in parallel in a descending order of the module voltage from the battery having the highest module voltage to the battery having the lowest module voltage in a discharge mode.

2. The battery pack of claim 1, wherein the plurality of batteries comprises a first battery having the lowest module voltage and a second battery having a second lowest module voltage,
wherein the module switches comprise a first module switch corresponding to the first battery, and a second module switch corresponding to the second battery, and
wherein the battery management unit, in the charge mode, is configured to charge the first battery by closing the first module switch, and to charge both the first battery and the second battery by closing the second module switch when the module voltage of the first battery increases, and a difference between the module voltage of the first battery and that of the second battery is smaller than a threshold value.

3. The battery pack of claim 1, wherein the plurality of batteries comprises a first battery having the highest module voltage, and a second battery having a second highest module voltage,
wherein the module switches comprise a first module switch corresponding to the first battery and a second module switch corresponding to the second battery, and
wherein, in the discharge mode, the battery management unit is configured to discharge the first battery by closing the first module switch, and to discharge both the first battery and the second battery by closing the second module switch when the module voltage of the first battery decreases, and a difference between the module voltage of the first battery and that of the second battery is smaller than a threshold value.

4. The battery pack of claim 1, wherein the plurality of batteries comprises first batteries coupled in parallel through first module switches that are in a closed state, and a second battery coupled to a second module switch that is in an open state, and
wherein when the first batteries are charged or discharged and a difference between the module voltages of the first batteries and the module voltage of the second battery is smaller than a threshold value, the battery management unit is configured to couple the second battery to the first batteries by closing the second module switch.

5. The battery pack of claim 1, wherein the plurality of batteries comprises a first battery having a first module voltage, and a second battery having a second module voltage, and
wherein when a difference between the module voltage of the first battery and that of second battery is smaller than a threshold value, the battery management unit is configured to close a first module switch corresponding to the first battery, and is configured to immediately close a second module switch corresponding to the second battery without charging or discharging the first battery.

6. The battery pack of claim 1, further comprising module management units and battery modules configured to be selectively coupled in parallel,
wherein each of the battery modules comprises:
a battery from among the plurality of batteries;
a module switch from among the module switches coupled to the battery in series; and
a module management unit from among the module management units configured to detect the module voltage of the battery, and to control closing and opening of the module switch.

7. The battery pack of claim 6, wherein the battery management unit comprises the module management units and a main management unit configured to communicate with each other,
wherein the main management unit is configured to receive the module voltages of the batteries from the module management units, and to transmit control commands to control the module switches to the module management units, and
wherein the module management units are configured to receive the control commands from the main management unit, and are configured to close or open the module switches according to the control commands.

8. The battery pack of claim 7, further comprising a main switch coupled between the battery modules and an output terminal,
wherein the main management unit is configured to control closing and opening of the main switch such that the main switch is open at a time when the module switches are switched from an open state to a closed state.

9. An energy storage system comprising:
a battery system comprising: a plurality of batteries selectively coupled in parallel through corresponding module switches;
a battery management unit configured to detect a module voltage of each of the plurality of batteries, control the module switches in order to couple the plurality of batteries in an ascending order of the module voltage in a charge mode, and control the module switches in order to couple the plurality of batteries in a descending order of the module voltage in a discharge mode; and
a power conversion system comprising:
power conversion apparatuses configured to convert electric power between the battery system and an electric power generator, a grid system, and/or a load; and
an integrated controller configured to control the power conversion apparatuses.

10. The energy storage system of claim 9, wherein the plurality of batteries comprises a first battery having a lowest module voltage, and a second battery having a second lowest module voltage, and
wherein the battery management unit is configured to charge the first battery by closing a module switch corresponding to the first battery in the charge mode, and is configured to couple the second battery to the first battery in parallel by closing a module switch corresponding to the second battery when the module voltage of the first battery increases, and the module voltage of the first battery becomes substantially the same as that of the second battery.

11. The energy storage system of claim 9, wherein the plurality of batteries comprises a first battery having a highest module voltage, and a second battery having a second highest module voltage, and
wherein the battery management unit is configured to discharge the first battery by closing a module switch corresponding to the first battery in the discharge mode, and is configured to couple the second battery to the first battery in parallel by closing a module switch corresponding to the second battery when the module voltage of the first battery decreases, and the module voltage of the second battery becomes substantially the same as that of the first battery.

12. The energy storage system of claim 9, wherein the plurality of batteries comprise first batteries coupled in parallel through first module switches that are closed, and a second battery coupled to a second module switch that is opened, and
wherein the battery management unit is configured to couple the second battery to the first batteries in parallel by closing the second module switch when the first batteries are charged or discharged, and the module voltages of the first batteries become substantially the same as the module voltage of the second battery.

13. The energy storage system of claim 9, wherein the plurality of batteries comprises a first battery having a first module voltage, and a second battery having a second module voltage, and
wherein the battery management unit is configured to close a module switch corresponding to the first battery, and to immediately close a module switch corresponding to the second battery without charging or discharging the first battery, when a difference between the first module voltage and the second module voltage is smaller than a threshold value.

14. The energy storage system of claim 9, wherein the power conversion apparatuses comprise a bidirectional converter configured to provide the battery system with electric power received from at least one of the electric power generator and the grid system in the charge mode, and to provide at least one of the load and the grid system with the electric power received from the battery system in the discharge mode,
wherein the battery management unit is configured to determine maximum charge allowable current and maximum discharge allowable current based on a number of batteries actually coupled in parallel, and to provide the bidirectional converter with information about the maximum charge allowable current and the maximum discharge allowable current, and
wherein the bidirectional converter is configured to provide the battery system with current that is smaller than the maximum charge allowable current in the charge mode, and to receive current that is smaller than the maximum discharge allowable current from the battery system in the discharge mode.

15. The energy storage system of claim 9, further comprising module management units, and battery modules configured to be selectively coupled in parallel,
wherein each of the battery modules comprises:
a battery from among the plurality of batteries;
a module switch from among the module switches coupled in series to the battery; and
a module management unit from among the module management units,
the module management unit being configured to detect the module voltage of the battery, and to control closing and opening of the module switch.

16. The energy storage system of claim 15, wherein the battery management unit comprises the module management units and a main management unit configured to communicate with each other,
wherein the main management unit is configured to receive the module voltages of the batteries from the module management units, and to transmit control commands to control the module switches to the module management units, and
wherein the module management units are configured to receive the control commands from the main management unit, and are configured to close or open the module switches according to the control commands.

17. A method of operating a battery pack comprising battery modules configured to be selectively coupled in parallel, the method comprising:
measuring a module voltage of each of the battery modules;
determining an operation mode of the battery pack;
coupling the battery modules in parallel in an ascending order of the module voltage when the operation mode is a charge mode; and
coupling the battery modules in parallel in a descending order of the module voltage when the operation mode is a discharge mode.

18. The method of claim 17, wherein the battery modules comprise a first battery module having a first module voltage, and a second battery module having a second module voltage that is greater than the first module voltage, and
wherein the coupling the battery modules in parallel in the ascending order of the module voltage comprises:
charging the first battery module;
coupling the second battery module to the first battery module in parallel when the first module voltage of the first battery module increases, and the first module voltage of the first battery module becomes substantially the same as the second module voltage of the second battery module; and
charging the first battery module and the second battery module in parallel,
wherein the coupling the battery modules in parallel in the descending order of the module voltage comprises:
discharging the second battery module;
coupling the first battery module to the second battery module in parallel when the second module voltage of the second battery module decreases, and the second module voltage of the second battery module becomes substantially the same as the first module voltage of the first battery module; and
discharging the second battery module and the first battery module in parallel.

19. The method of claim 17, wherein the battery modules comprise a first battery module having a first module voltage, and a second battery module having a second module voltage that is higher than the first module voltage by a value that is smaller than a threshold value, and
wherein the coupling the battery modules in parallel in the ascending order of the module voltage comprises:
coupling the first battery module;
coupling the second battery module to the first battery module in parallel without charging the first battery module; and
charging the first battery module and the second battery module in parallel, and
wherein the coupling the battery modules in parallel in the descending order of the module voltage comprises:
coupling the second battery module;
coupling the first battery module to the second battery module in parallel without discharging the second battery module; and
discharging the second battery module and the first battery module in parallel.

20. The method of claim 17 further comprising:
determining maximum charge allowable current and maximum discharge allowable current based on a number of batteries coupled in parallel whenever the battery modules are coupled in parallel; and
providing information about the maximum charge allowable current and the maximum discharge allowable current to an external apparatus.
